(19) United States
(12) Patent Application Publication
(10) Pub. No.: US 2007/0087103 A1
(43) Pub. Date: Apr. 19, 2007

(54) Acidified milk products containing pectin

(76) Inventors: Soeren Bulow Riis, Rodovre (DK); Claus Rolin, Koge (DK)

Correspondence Address: David M. Goodrich, Esq.;J. M. Huber Corporation, 333 Thornall Street, Edison, NJ, 08837-2220, US

(21) Appl. No.: 11/250,242

(22) Filed: Oct. 14, 2005

(51) Int. Cl. A23C 9/154

(52) U.S. Cl. 426/580

(57) ABSTRACT

Disclosed is a milk beverage comprising: a pectin extracted from a citrus source, the pectin having: (1) a degree of esterification in range of 55% to 65%, and (2) calcium sensitivity index between 10 and 30; wherein the pH of the milk beverage is between 4.3 to 4.5.

### BACKGROUND OF THE INVENTION

Fermented milk products are among the most widely consumed foods in the world today, enjoyed by peoples of nearly all cultures and backgrounds. Yogurt (a milk product fermented with L. bulgaricus and S. thermophilus, that typically has a pH of less than 5.0) is perhaps the most well-known fermented milk product, but other popular fermented milk products include kefir in central Asia, YAKULT™ in Japan, and Ymer in Denmark.

While yogurt remains a very popular comestible item, there is also a growing demand for liquid yogurt drinks. These yogurt drinks have the advantage of being more portable, easier and more convenient to consume than yogurt.

Yogurt drinks often make use of pectin as a stabilizer against sedimentation of the milk solids that are found in yogurt. Pectin is a stabilizing material extracted from plants such as fruits and vegetables. Pectin is a particularly good stabilizer at pHs of between 3.7 to 4.3, (which are the most typical pHs for commercial yogurt drinks, and directly acidified milk drinks, providing excellent stabilization of milk solids, particularly the casein and whey protein solids. Recently, however, there has been a desire among yogurt drink producers for yogurt drinks with milder taste notes, requiring pHs of greater than 4.3 and as much as 4.6. Unfortunately, as the pH of the yogurt drink increases, pectin becomes less effective as a stabilizer, requiring an increase in the concentration of pectin. However, as the pectin concentration increases so does the viscosity of the milk drink. At a pH in the range of 4.3 to 4.6 the viscosity tends to be high, and in particular it will be difficult to have a consistent viscosity from batch to batch production of yogurt drinks. Further some customers prefer yogurt drinks where the viscosity of the yogurt drinks remain sufficiently low so that the milk drink can be easily poured or drunk directly out of the container.

Accordingly, there is a need in the art for a pectin stabilized milk drink product that has a pH of greater than 4.3, and a viscosity sufficiently low so that the milk drink is suitable for drinking and pouring.

### BRIEF SUMMARY OF THE INVENTION

The present invention is a milk beverage comprising: a pectin extracted from a citrus source, the pectin having: (1) a degree of esterification in range of 55% to 65%, and (2) calcium sensitivity index between 10 and 30; wherein the pH of the milk beverage is between 4.3 to 4.6.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a graphical presentation of the sediment fraction percentage of a yogurt drink of pH 4.50 prepared according to present invention, and a yogurt drink of pH 4.50 prepared according to prior art with several different pectin concentrations.

FIG. 2 is a graphical representation of the viscosity in mPa·s of a yogurt drink of pH 4.50 prepared according to the present invention, and a yogurt drink of pH 4.50 prepared according to the prior art with several different pectin concentrations.

FIG. 3 is a graphical presentation of the sediment fraction percentage of a yogurt drink of pH 4.30 prepared according to present invention, and a yogurt drink of pH 4.30 prepared according to prior art with several different pectin concentrations.

FIG. 4 is a graphical representation of the viscosity in mPa·s of a yogurt drink of pH 4.30 prepared according to the present invention, and a yogurt drink of pH 4.30 prepared according to the prior art with several different pectin concentrations.

FIG. 5 is a graphical presentation of the sediment fraction percentage of a yogurt drink of pH 4.10 prepared according to present invention, and a yogurt drink of pH 4.10 prepared according to prior art with several different pectin concentrations.

FIG. 6 is a graphical representation of the viscosity in mPa·s of a yogurt drink of pH 4.10 prepared according to the present invention, and a yogurt drink of pH 4.10 prepared according to the prior art with several different pectin concentrations.

### DETAILED DESCRIPTION OF THE INVENTION

All parts, percentages and ratios used herein are expressed by weight unless otherwise specified. All documents cited herein are incorporated by reference.

The present invention is directed towards an acidified milk drink containing a pectin that effectively stabilizes milk solids in the milk drink even at relatively high pHs such as in the range of 4.3 to 4.6. By effectively stabilizing the milk solids at higher pHs, a yogurt drink prepared according to the present invention is produced that has a milder taste note than comparable yogurt and milk drinks with lower pHs.

Acidified Milk Products

In its most basic form milk is a suspension of milk solids in a continuous aqueous phase. The milk solids include both fats and a non-fats portion commonly referred to as milk solids non-fats (“MSNF”). The MSNF include proteins (such as whey proteins and casein) and carbohydrates, as well as trace components like organic acids and minerals and vitamins. While all of the aforementioned components contribute to milk's nutritional values, processing and storage behavior, and sensory characteristics, the casein component is the most relevant to the present invention.

Caseins are protein micelles with spherical diameters of about 20 to 400 nm. As micelles the caseins remain in colloidal form, suspended in the milk. However, maintaining the colloid state is dependent on the pH of the suspension. At a milk pH of about 5.0 (or even as high as 6.5 for a milk drink subjected to heat treatment), the casein starts to lose coherence and begins to precipitate out of the suspension, and at a milk pH of about 4.5, precipitation is complete. Thus, for milk products formulated to a pH of well below 5.0 (such as yogurt and yogurt drinks) the casein particles are always present in their precipitated phase rather than as colloidal micelles. Accordingly, pectin is added to a milk drink in order to prevent the non-micellar casein from precipitating out of the milk and forming sediment.

The acidified milk drinks can be divided into two categories: directly acidified milk drinks and yogurt drinks. The directly acidified milk drink are made by acidifying milk by use of acid and/or fruit concentrate whereas yogurt drinks are acidified by fermenting milk with L. bulgaricus and S. thermophilus. After fermentation the yogurt drink may be diluted with water and may additionally be stabilized with a hydrocolloid, such as pectin. Yogurt drinks themselves can be divided into two categories: (1) those with a 1-4% MSNF content, which are usually pasteurized after fermentation to obtain a long shelf life; and (2) yoghurt drinks with higher milk solids, 4-8.5% MSNF, that typically contain live, sometimes probiotic, cultures thus necessitating refrigeration.

Pectin

Pectin has long been used in milk products, like the presently disclosed acidified milk products, in order to stabilize the product and prevent sedimentation of milk casein and whey particles. Pectin is particularly prized because it is suitable for use in food comestibles, and at normal concentration levels does not increase the viscosity of the milk product to unacceptably high levels.

Pectins are natural materials that occur in most higher plant forms, forming the major structural components in the primary cell wall and middle lamella of young and growing plant tissues. The structure of pectin itself can be defined as 1,4-linked alpha-D-galactopyranosyluronic acid units in the ⁴C₁ conformation, with the glycosidic linkages arranged diaxially. One critical characteristic of the pectin structure that has a significant affect on the pectin's behavior and performance is what fraction of the carboxyl groups attached to the galactopyranosyluronic acid units are esterified with methanol. In commercial usage, pectins having a degree of esterification of less than 50% (i.e., less than 50% of the carboxyl groups are methylated to form methyl ester groups) are classified as low-ester pectins (or “LM-pectins”) while those pectins having a degree of esterficiation of greater than 50%, (i.e., more than 50% of the carboxyl groups are methylated) are classified as high-ester pectins (or “HM-pectins”). The present invention will relate primarily to HM-pectins. Preferably, the pectins of the present invention will have a DE of about 55% to about 65%, more preferably of about 57% to about 63%.

The pectin manufacturer can, to some extent, control the DE of the pectin by appropriate processing steps and conditions well known to skilled persons. Typically, pectin is commercially produced by suspending pectin-rich plant tissue in warm acidified water for some time. This part of the pectin manufacturing is commonly referred to as the “extraction”; it converts the insoluble form of pectin as it exists in plants (often referred to as “protopectin”) to soluble pectin which then leaches into the solution. Later, the pectin is recovered from said solution by separation processes. If high DE is desired, normally less acid is used for the extraction as compared to the amount of acid used if lower DE is desired.

The DE can be further reduced by treating the pectin solution with acid or with an enzyme that de-esterifies pectin. Such enzymes, generically referred to as pectin esterases, are well-known. The acid, as well as the enzymes, hydrolyse some of the methyl-esterified carboxyl groups producing non-esterified carboxyl groups and methanol. However, while acid and some enzymes apparently pick the carboxyl groups to be de-esterified either at random or in a regular way, other enzymes de-esterify in such a way that blocks of consecutive free carboxyl groups occur in the molecules. The latter enzymes occur naturally in citrus fruit and may to varying extent create blocks in the pectin before the extraction process. A pectin manufacturer can thus to some extent manipulate not only the DE, but also the “blockiness”. If a rather pronounced blockiness is desired this can be accomplished either by selecting a citrus raw material that has been affected by esterase (e.g., orange), by exposing the dissolved extracted pectin to a block-creating pectin esterase, or both. If blockiness is not desired, the manufacturer may select raw-material that has been less affected by esterase and use either acid or an enzyme, that does not create block, for reaching the desired DE.

The creation of these long blocks of demethylated galacturonic acid units has important consequences for the performance of the pectin material as a stabilizer in a milk drink. With acidified milk beverages having a pH of approximately 4.0, pectin of sufficient blockiness is more effective than pectin of relatively low blockiness as is described in the prior art. The (negatively charged) blocks adsorb strongly to the surfaces of the protein particles, which in the absence of pectin possess surplus positive charge at the pH level of acidified milk drinks. Further, two or more blocks can become attracted to each other in the presence of calcium ions which occur abundantly in milk products. For the latter reason, pectin with high blockiness is less soluble in the presence of calcium ions, and this reduced solubility can result in a thickening or gelling of the solution; in the creation of pectin-enriched lumps; or in precipitation of the pectin. Which one of the aforementioned colloidal or precipitated solutions is produced depends on a number of factors such as the pectin DE, the pectin blockiness, the concentration of Ca²⁺ ions, the pH, the presence of other dissolved materials, temperature and other possible factors. In general, the tendency for a two-phase system (i.e., the formation of lumps or a precipitate), is greatest when there is a high attraction between blocks and low concentration of pectin. Vice versa, there is tendency for a homogeneous solution (or a macroscopically homogeneous gel) if there is high concentration of pectin and less attraction between blocks. The attraction between blocks, in turn, becomes more prevalent with the presence of blocks in the molecules, with the presence of Ca²⁺ ions, and with increasing pH (within the relevant pH range for acidified milk drinks).

The attraction between pectin and milk protein stabilizes the protein because it wraps the protein particles in a hydrophilic coating. While unstabilized protein particles (i.e., those without a hydrophilic coating) can form aggregates that do not bind water, and thus can form a relatively compact sediment, the stabilized particles (i.e., those with a hydrophilic coating) cannot aggregate by direct protein-protein interaction, and cannot separate from water. The self-association of pectin with Ca²⁺ ions may enhance the stability by capturing the particles in a weak gel, but it is not known how important this further contribution to stability is.

The thickened texture that can result from pectin self-association with Ca²⁺ ions is sometimes desirable but also sometimes undesirable. Some manufacturers of acidified milk beverages endeavor to make the beverage as thin as possible, and there is an unsatisfied need for stabilizers that can impart low viscosity in stable beverages at pHs in the range of 4.3 to 4.6, which is slightly higher than the typical pH range of prior art beverages. Other manufacturers prefer a creamier mouthfeel and higher viscosity.

The typical pH of acidified milk drinks is between 3.7 and 4.3, but it is desired to formulate beverages of pH 4.3 to 4.6 in order to create a milder, less tart, taste impression. With increasing pH within the pH range of 4.3 to 4.6, the efficacy of prior art pectin decreases, and in order to obtain acceptable stability it becomes necessary to increase the dosage of pectin and accept a much thicker texture. The known consequence of the increased pH is that the carboxylic acid groups on the pectin as well as on the protein particles become less neutralized from protons, so the surplus positive charge of the protein particles declines, and the tendency for pectin to self-associate with Ca²⁺ ions increases.

The self-association of pectin block structures with Ca²⁺ ions can as previously explained under appropriate circumstances create viscosity in a pectin solution with Ca²⁺ ions, which is larger than the viscosity that would be expected from a solution without Ca²⁺ ions. This phenomenon is commonly termed pectin calcium sensitivity, and a protocol for characterizing pectin by measuring the viscosity of a specified solution with pectin and Ca²⁺ ions is termed a calcium sensitivity method. One such method is described in greater detail below. The pectins of the present invention will have a calcium sensitivity index of between about 10 to about 30.

While not intending to being limited by theory, it is believed that in the present invention an acidified milk drink with a relatively high pH range (and thus, less acidic taste and sensory characteristics) can be formulated by preparing a pectin that has a combination of (1) a degree of esterification that is lower than that of pectins commonly used in stabilizing milk drinks; (2) a fairly low calcium sensitivity; and (3) is extracted from a citrus source, such as limefruit. The combination of these three characteristics of the pectin is believed to interact in the following manner in the present invention: at the higher pH, it is still possible to affix negative pectin charges to positive amino charges of the protein. The number of amino charges (having pK much above 7) is essentially independent of pH within the range 3.7 to 4.6. However, at the high end of this interval, the waiting time for a physical occurrence (such as diffusion or applied shear) that brings a pectin molecule in close contact with these charges, so that adsorption occurs, is much longer, because the increased number of protein carboxyl groups creates a repulsive force. The higher pH increases the reactivity between pectin and Ca²⁺ ions, so the tendency for pectin self-association increases and increases the possibility of an interaction that can result in a two-phase systems (e.g., pectin-enriched lumps). Prior art pectin stabilizers thus become ineffective, because the protein surfaces do not receive enough pectin before pectin self-association with Ca²⁺ ions takes place and makes the pectin unavailable for adsorption. The pectin according to the present invention reduces this problem by being less Ca-sensitive. In the absence of the blocks of consecutive free carboxyl groups, the molecules need a lower average DE in order to possess molecular areas of sufficient negative charge for anchoring to protein amino groups.

Measuring the Calcium sensitivity of Pectins

The calcium sensitivity index is measured as follows. First, two sodium acetate buffer (pH=3.6) solutions are created, with the first solution having a volume of 2 L and the second solution having a volume of 5 L. The solutions are prepared as follows: 81.64 g of sodium acetate trihydrate is dissolved in approximately 1200 mL of ion exchanged water, and this aqueous solution of sodium acetate trihydrate is then mixed with 309 mL of acetic acid. A sufficient amount of ion-exchanged water is then added to bring the volume up 2000 mL—and the final buffer solution measured to ensure that it is at a pH of 3.60±0.05. The 5 L second solution is prepared in an analogous fashion except that the final target volume was 5000 mL, and to prepare this, an initial supply of 204 g of sodium acetate trihydrate is used in a mixture amount of 772 mL of acetic acid. Next a calcium chloride solution is prepared by adding 32 g calcium chloride dihydrate into an empty measuring flask and then adding about 200 mL of ion-exchanged water into the flask and mixing the content, and then again subsequently adding ion-exchanged water to bring the volume to 1000 mL.

Pectin is then added to a viscosity glass in the amount of 0.64 g (an amount that corresponds to a pectin concentration of 0.4 wt %). 5.0 mL of isopropanol is then added and the sample agitated with a magnetic stirrer while adding 130 mL boiling water (temperature at least 85° C.). (Note that as the stirring begins and the subsequent mixing steps set forth below, the viscosity glass is covered (e.g., with foil). Next 20 mL of the 3 M 3.6 pH aqueous sodium acetate buffer is added 1 min after adding the boiling water. Within 1 minute of adding the aqueous buffer the pectin sample is placed in a 75° C. water bath and stirred for approximately 10 minutes.

The sample is then visually inspected. If lumps are seen, it is discarded and the dissolving process started again. If no lumps are detected the cover is removed and the sample is stirred with a vortex of approximately 2 cm. Then 5 mL of the calcium chloride is added to the sample and mixed for approximately 10 seconds. (It is important to monitor the addition of the calcium chloride: if upon being added the vortex disappears and local gelation, entrapped air bubbles, or both are observed, then the sample has gelled and must be discarded.)

The magnetic stirrer is then removed and the glass covered with foil. The sample is placed in a water bath (this must happen no later than five minutes from the first addition off the CaCl₂) at 5° C. for about 19 hours.

After aging in the water bath, any entrapped air bubbles present on the sample surface should be gently removed prior to viscosity measurements using a Brookfield LVT viscometer without its protective loop. The sample viscosity was measured at 5° C. using spindle no. 2 and spindle speed of 60 rpm after 1 minute. If the viscosity measurement was below 10, the spindle is changed to the no. 1 spindle and the viscosity remeasured at 60 rpm after 1 minute. If the reading is above 100, the sample is placed in the 5° C. water bath for 19 hours and the 1 minute viscosity is remeasured using spindle no. 3 at 60 rpm. The viscosity in centipoises is calculated by multiplying the viscometer reading by the appropriate spindle-dependent factor. The calcium sensitivity index is equal to the calculated viscosity.

The invention will now be described in more detail with respect to the following, specific, non-limiting examples.

### EXAMPLES

Yogurt drinks according to the present invention, and prior art were prepared as follows.

First, a yogurt stock (8.5% MSNF, with live culture) was prepared by weighing out the yogurt and shearing it with a Silverson high-speed mixer until it took on a shiny sheen. While being sheared in the Silverson high-speed mixer the yogurt was titrated with a NaOH solution while shearing with the Silverson until the pH reached 4.55±0.02 for yogurt drinks with a final pH of 4.50, and to 4.35 (±0.02) for yogurt drinks with a final pH of 4.30. For yogurt drinks with a final pH of 4.10 the pH of the yogurt was not adjusted. Finally sucrose was added and water added for further dilution.

Pectin solutions according to the present invention (which are denoted in the present example as “high pH” pectins) and pectins prepared according to the prior art were prepared by first diluting pectin stock solution in deionized water using a Silverson mixer; then heating the pectin solution by immersing the solution into a 75° C. water bath for 20 minutes, making sure that the solution reaches a temperature of above 70° C. within 10 minutes; and finally cooling the pectin solution to 5° C.

Finally, yogurt drinks were prepared by mixing the pectin solutions prepared above and water and then adding the yogurt (again prepared above) under continued stirring which continues for at least one minute after the last addition of water to make sure that the acidified milk drink solution so created is homogeneous. The milks were further homogenized at pressures of between 150 to 180 bars. As mentioned previously, yogurt drinks were prepared according to the present invention and the prior art.

Samples of the yogurt drinks were transferred to centrifugal tubes for sedimentation testing and viscosity glasses for viscosity testing. Sedimentation testing was conducted as follows. 10 g of the acidified milk drink was transferred to a centrifuge tube and centrifuged for 20 minutes at approximately 3000 g. The supernatant was then drained off and the tube placed upside down to drain any last portions of liquid from the tube. The tube was then weighed with the solids remaining in the centrifuge tube representing the sedimentation fraction.

Viscosity testing was conducted as follows. One viscosity glass for each solution is left untouched for 18-24 hours at 5° C. The viscosity is measured with Brookfield Viscosimeter type LVT (60 rpm), using the UL Adapter when the viscosity is lower than 10 mPa·s. The viscosity is read after a 1 minute rotation.

This testing protocol was performed in three different series of samples with 8.5% MSNF in the final yogurt drink with live culture and the pectin concentration was varied from 0% to 0.5%. In a first series of sample, the pH of the yogurt drinks was 4.5, in the second 4.3, and in the third 4.1. In all tests the results from the yogurt drink with the “high pH” pectin prepared according to the present invention were compared to the results from the yogurt drinks with pectin prepared according to the prior art.

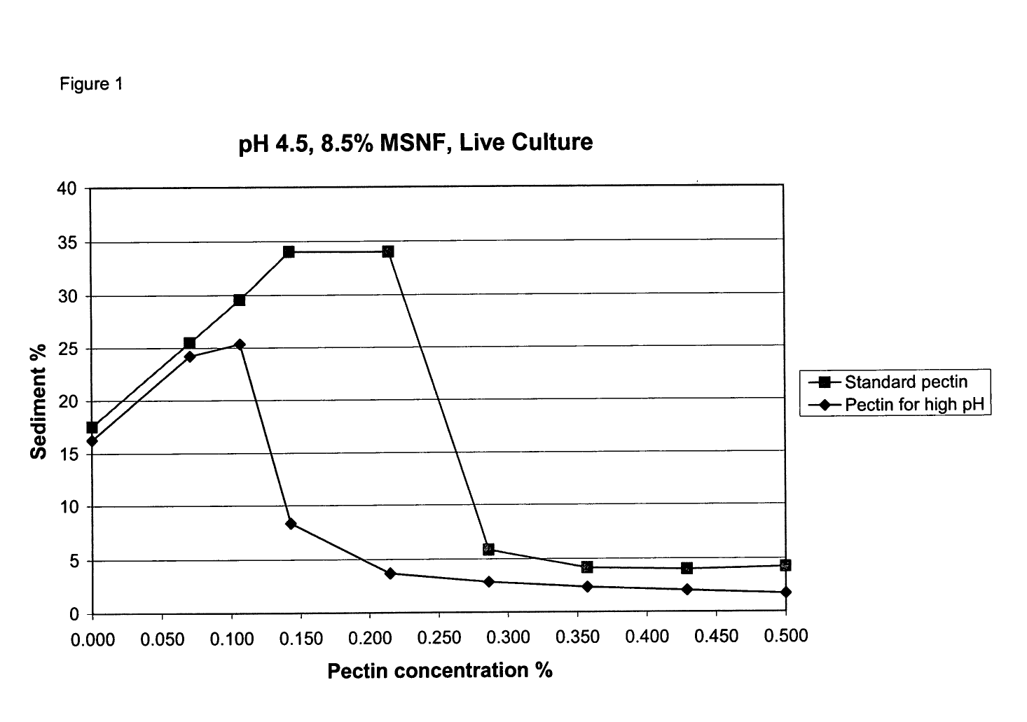

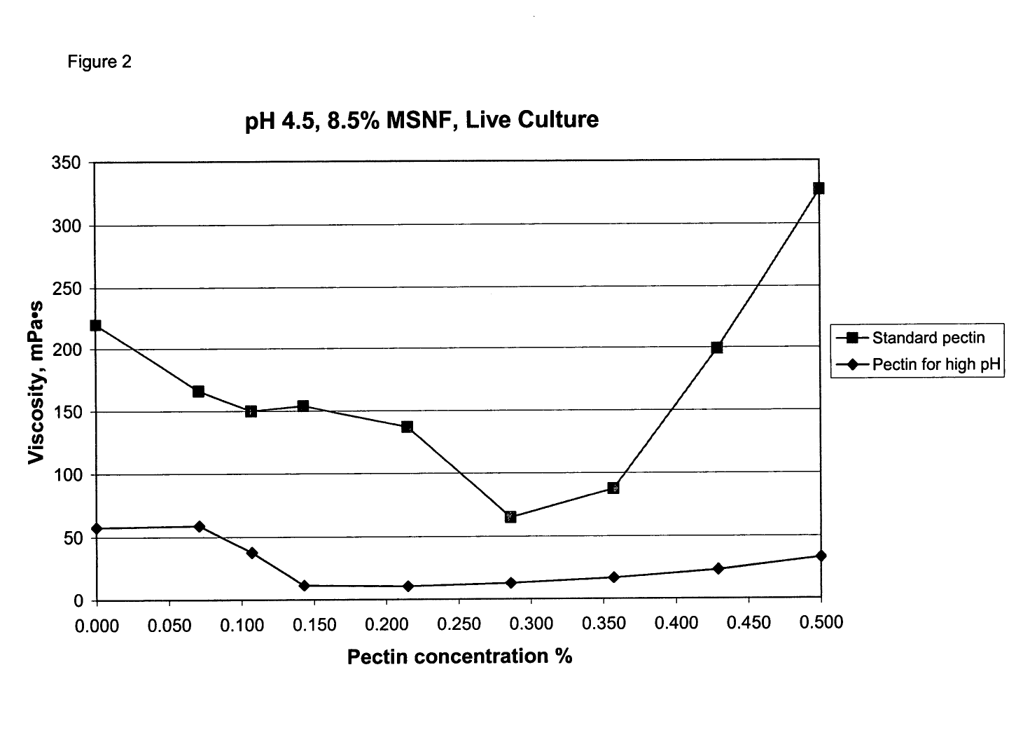

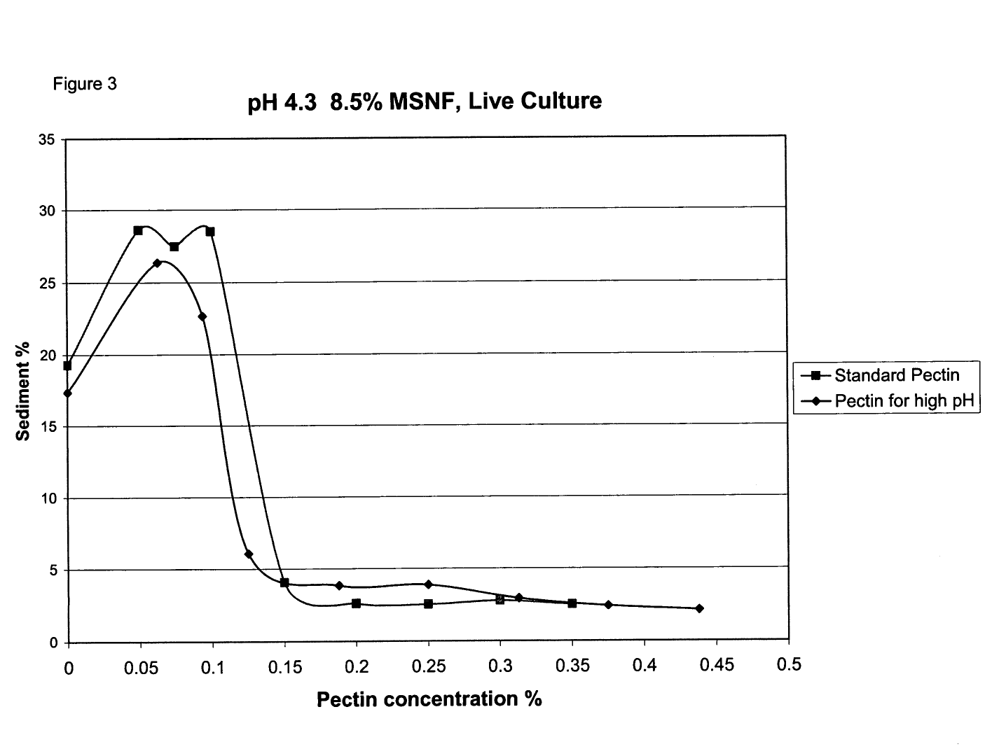

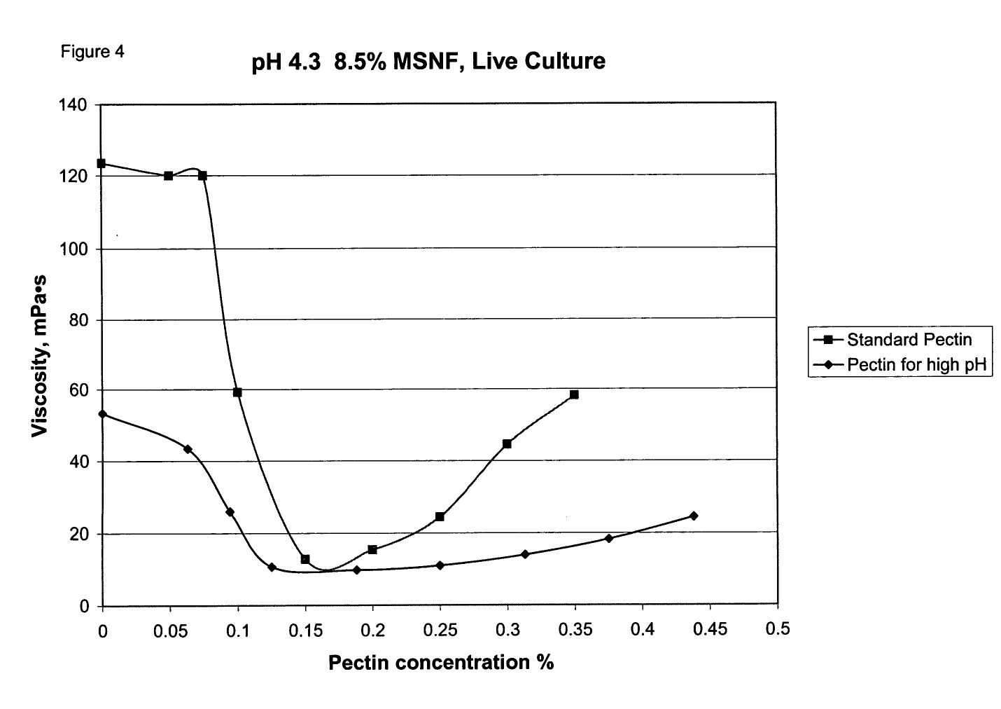

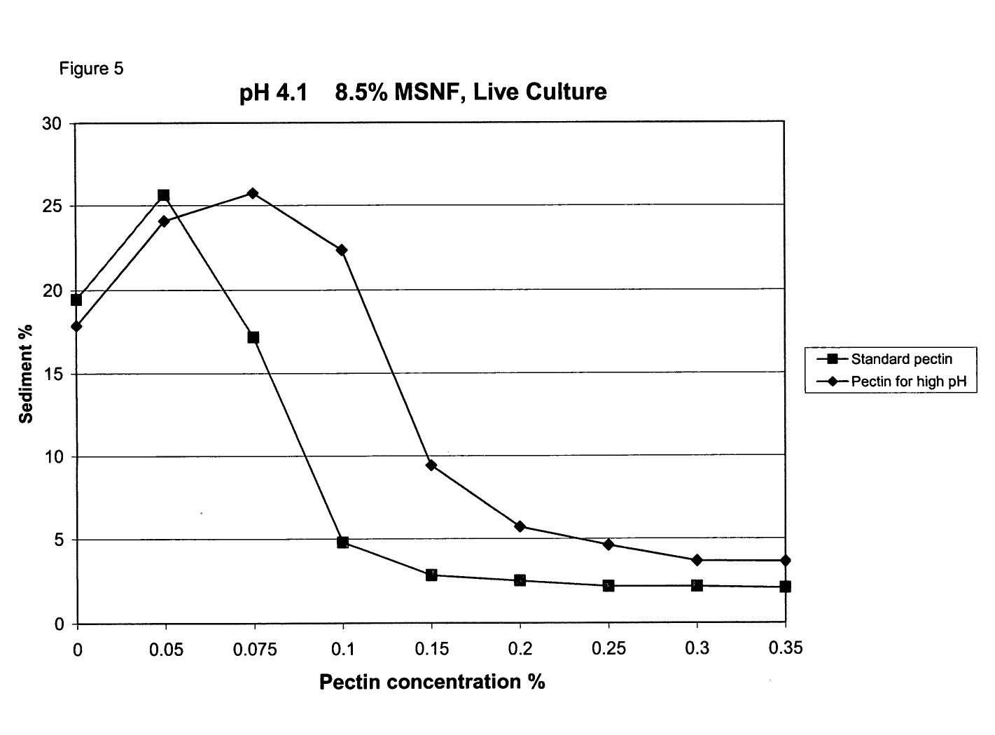

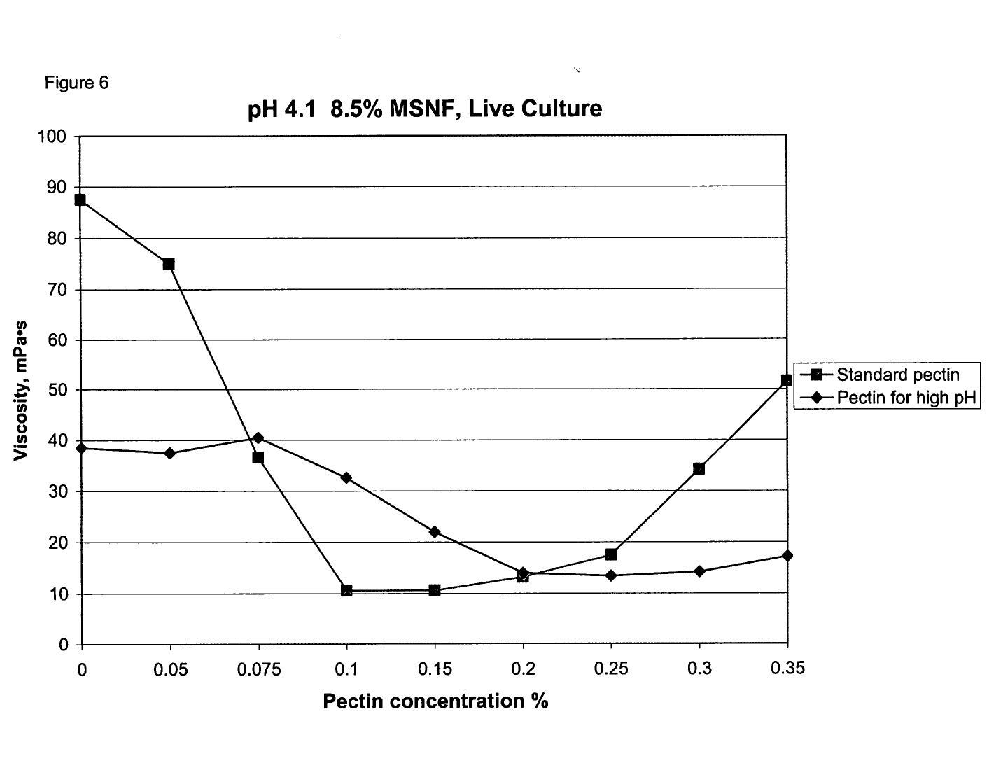

The sedimentation and viscosity results for live culture yogurt drinks with 8.5% MSNF and pH 4.5, 4.3, and 4.1 are set forth in tables 1, 2 and 3, below in tables 1, 2, and 3, respectively, below. These results are also shown graphically in the attached figures: FIGS. 1 and 2 shows the results for table 1, FIGS. 3 and 4 shows the results for table 2, and FIGS. 5 and 6 shows the results for table 3.

TABLE 1
Sediment and Viscosity values at pH = 4.5

| | | | Yogurt drink | Yogurt drink |
|---|---|---|---|---|
| | Yogurt drink | Yogurt drink | “high pH” | prior art |
| | “high pH” | prior art | pectin - | pectin - |
| Pectin | pectin - % | pectin - % | viscosity in | viscosity in |
| concentration | sediment | sediment | mPa · s | mPa · s |
| 0.000 | 16.27 | 17.54 | 57.7 | 220.0 |
| 0.071 | 24.2 | 25.49 | 58.8 | 166.0 |
| 0.107 | 25.35 | 29.56 | 37.7 | 150.0 |
| 0.143 | 8.35 | 34.03 | 11.5 | 154.0 |
| 0.215 | 3.69 | 34.01 | 10.6 | 137.0 |
| 0.286 | 2.85 | 5.83 | 12.8 | 65.0 |
| 0.357 | 2.33 | 4.15 | 17 | 87.3 |
| 0.429 | 2.01 | 4.01 | 23.5 | 199.0 |
| 0.500 | 1.71 | 4.22 | 33.2 | 327.0 |

TABLE 2
Sediment and Viscosity values at pH = 4.3

| | | Yogurt | | | |
|---|---|---|---|---|---|
| | Yogurt | drink | | Yogurt | Yogurt |
| Pectin | drink | “high pH” | Pectin | drink | drink prior |
| Concentration - | “high pH” | pectin- | Concentration | prior art | art pectin - |
| “high pH” | pectin - % | viscosity | prior art | pectin - % | viscosity |
| pectin | sediment | in mPa · s | pectin | sediment | in mPa · s |
| 0 | 17.34 | 53.3 | 0.000 | 19.28 | 123.5 |
| 0.063 | 26.38 | 43.4 | 0.050 | 28.60 | 120.0 |
| 0.094 | 22.68 | 26 | 0.075 | 27.49 | 120.0 |
| 0.125 | 6.05 | 10.7 | 0.100 | 28.50 | 59.2 |
| 0.188 | 3.85 | 9.8 | 0.150 | 4.07 | 12.8 |
| 0.25 | 3.88 | 11 | 0.200 | 2.61 | 15.4 |
| 0.313 | 2.95 | 14 | 0.250 | 2.55 | 24.4 |
| 0.375 | 2.44 | 18.3 | 0.300 | 2.79 | 44.5 |
| 0.438 | 2.14 | 24.4 | 0.350 | 2.54 | 58.2 |

TABLE 3
Sediment and Viscosity values at pH = 4.1

| | | | Yogurt drink | Yogurt drink |
|---|---|---|---|---|
| | Yogurt drink | Yogurt drink | “high pH” | prior art |
| | “high pH” | prior art | pectin - | pectin - |
| Pectin | pectin - % | pectin - % | viscosity in | viscosity in |
| concentration | sediment | sediment | mPa · s | mPa · s |
| 0.000 | 17.88 | 19.45 | 38.5 | 87.5 |
| 0.050 | 24.08 | 25.64 | 37.5 | 75.0 |
| 0.075 | 25.74 | 17.18 | 40.5 | 36.6 |
| 0.100 | 22.38 | 4.79 | 32.6 | 10.6 |
| 0.150 | 9.42 | 2.85 | 22 | 10.6 |
| 0.200 | 5.71 | 2.53 | 14 | 13.2 |
| 0.250 | 4.61 | 2.20 | 13.4 | 17.5 |
| 0.300 | 3.69 | 2.19 | 14.2 | 34.2 |
| 0.350 | 3.66 | 2.10 | 17.2 | 51.5 |

As can be seen above, the “high pH” pectin in the yogurt drinks of pH 4.5 is much better at stabilizing the acidified milk drink against sedimentation than the prior art pectin. At concentration levels as low as about 0.215, the “high pH” reduces the sedimentation to below 5% sedimentation fraction. By contrast, prior art pectins require 0.357% pectin to reduce the sedimentation to below 5% sedimentation fraction. Not only does this higher pectin concentration increase cost, but it also provides an uncontrolled increase in the viscosity of the yogurt drink, which makes it difficult to make consistent viscosity from yogurt drink batch to yogurt drink batch, and which is not desired for customers who prefer a thin mouthfeel. From table 2 it can be seen that the “high pH” pectin and the prior art pectin performs equally well with respect to stabilizing the yogurt drinks of pH 4.3 against sedimentation. For viscosity it is observed that the prior art pectin builds up more viscosity than the “high pH” pectin, indicating that the “high pH” pectin also at this pH will give a more consistent viscosity from yogurt drink batch to yogurt drink batch. From table 3 it can be seen, that at the more common pH for live culture yogurt drinks, pH 4.1, the prior art pectin is much better at stabilizing the yogurt against sedimentation than the “high pH” pectin. Such significantly improved sedimentation performance in yogurt drinks with pH 4.5, as illustrated in table 1 above, would not have been expected by a person of ordinary skill in the art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A milk beverage comprising:
a pectin extracted from a citrus source, the pectin having: (1) a degree of esterification in range of 55% to 65%, and (2) calcium sensitivity index between 10 and 30;
wherein the pH of the milk beverage is between 4.3 to 4.6.

2. The milk beverage of claim 1, wherein the citrus source is limefruit.

3. The milk beverage of claim 1, wherein the milk beverage has a MSNF content of about 1 wt % to about 3 wt %

4. The milk beverage of claim 1, wherein the milk beverage has a MSNF content of about 5 wt % to about 8 wt %

5. The milk beverage of claim 1, wherein the degree of esterification is in the range of 57% to 63%

6. The milk beverage of claim 4 containing live probiotic culture

7. The milk beverage of claim 3 wherein the beverage has been pasteurized.

8. The milk beverage of claim 1, wherein the pH of the milk beverage is between 4.3 to 4.5.
